(19) United States
(12) Patent Application Publication
(10) Pub. No.: US 2013/0269039 A1
(43) Pub. Date: Oct. 10, 2013

(54) DATA ACCESS CONTROL

(71) Applicants: Israel Gold, Haifa (IL); Yechiel Yochai, Moshav Aviel (IL); Julian Satran, Atlit (IL)

(72) Inventors: Israel Gold, Haifa (IL); Yechiel Yochai, Moshav Aviel (IL); Julian Satran, Atlit (IL)

(73) Assignee: INFINIDAT LTD., Herzliya (IL)

(21) Appl. No.: 13/438,850

(22) Filed: Apr. 4, 2012

(51) Int. Cl. G06F 21/64

(52) U.S. Cl. CPC G06F 21/64
USPC 726/27

(57) ABSTRACT

The presently disclosed subject matter includes a system and method for protecting data stored in a physical storage space of a storage system. According to the teachings disclosed herein, a block key is provided together with a read and a write request and is applied on data, which is related to a logical data block, for calculating a data block signature. A read request according to the presently disclosed subject matter includes, in addition to data indicative of a requested data block, a block key for the purpose of verifying the data block signature that was stored upon the last write of the requested data block. A write request according to the presently disclosed subject matter includes, in addition to data indicative of a data block to be written, a block key for generating a respective data block signature.

### FIELD OF THE PRESENTLY DISCLOSED SUBJECT MATTER

The presently disclosed subject matter is relates to controlling access to stored data blocks and more specifically to controlling access to stored data blocks that are represented by one or more logical objects.

### BACKGROUND

Maintaining data integrity and data security are two principal concerns of storage systems. Data integrity refers to the accuracy and completeness of stored data and data security refers to the protection of data from access by an unauthorized entity.

Maintaining data integrity is essential, since losing even a few bytes of information, that composes critical portions of the information, can have disastrous implications. Data integrity is maintained by protecting stored data against data corruption and by detecting and possibly correcting corrupted data. Data corruption includes bit flips, misdirected I/O, lost I/O, etc.

Storage systems use checksums to protect against data corruption problems and maintain data integrity. Most modern disk drives can be formatted with sectors that are slightly larger than the usual 512 bytes, typically 520 or 528 bytes sectors. These extra bytes can be used to hold a block checksum. Before writing a data block to a disk, a checksum is calculated and appended to the data block on the disk. When the data block is read from the disk, a new checksum is calculated and compared to the checksum read with the data block. If the read checksum does not match the calculated checksum, the read data is rejected. If the storage system employs for example, a minor or RAID group it can be used for correcting an error in the data. The checksum is used to determine which copy is correct, provide good data to a requesting entity, and repair the damaged copy.

However, when using a checksum that is stored along with the associated data the effectiveness of a checksum depends to a great extent on where it is stored and when it is evaluated. Data corruption such as sector slides, misdirected reads and writes, firmware bugs such as phantom writes (the previous write never made it to disk) and lost sectors would not be detected at the disk sector level. For this type of corruption, a checksum computed from the sector data would match the stored checksum, because as the data and checksum are stored as a unit, they are self-consistent.

If, on the other hand, checksums are stored in reserved locations separate from the associated data, a separate read or write operation of the checksum is required for every read or write operation of the associated data. This can result in performance loss.

U.S. Pat. No. 6,952,797 of Kahn et al. discloses a block appended checksum. For each 4,096-byte file block, a corresponding 64-byte block-appended checksum is appended to the file block. The block-appended checksum includes a checksum of the data block, a Volume Block Number (VBN), which specifies the location of a block in a volume, a Disk Block Number (DBN), which specifies the location of a block in a disk, and an embedded checksum for checking the integrity of the block-appended checksum itself. The block-appended checksum reliably detects corruption of data within a sector such as bit flips, as does a sector checksum. However, a block-appended checksum also reliably detects data corruption across sectors including sector slides, misdirected reads and writes, and lost sector I/O.

While the above solutions assist in maintaining data integrity to some degree, additional solutions are required for improving the maintenance of data integrity and data security.

### SUMMARY

According to the presently disclosed subject matter there is provided a method of storing data in a physical storage space of a storage system, the physical storage space constituted by a plurality of physical data blocks, the method comprising: receiving a protected write request related to a logical object, logically representing data stored in the physical storage space; the request comprises data to be written, related to a logical data block in the logical object, and a respective block key; the block key comprises data identifying the logical object and data identifying the logical data block; calculating a respective data block signature based on the data to be written and on the block key; storing the data to be written and the respective data block signature in a same physical data block.

According to certain embodiments the block key further comprises a security code identifying an accessing entity.

According to certain embodiments the logical object is represented by a data-structure, the data-structure comprising at least one path comprising a sequence of one or more metadata blocks referring to a respective data block; each of the one or more metadata blocks comprising a reference to a descendent metadata block or to a respective data block; the method further comprising: for one or more metadata blocks along the at least one path: calculating a respective metadata block signature based on data related to a metadata block, the data identifying the logical object and a metadata block identifier associated with the metadata block; storing the data related to the metadata block and the respective metadata block signature in a same data block.

According to another aspect of the presently disclosed subject matter there is provided a method of storing data in a physical storage space of a storage system, the physical storage space constituted by a plurality of physical data blocks, the method comprising: receiving a protected read request related to a logical data block in a logical object, logically representing data stored in the physical storage space; wherein the protected read request comprises a respective block key; the block key comprises data identifying the logical object and data identifying the logical data block; reading a physical data block including data related to the logical data block and an associated stored data block signature; calculating a second data block signature based on the data related to the logical data block and on the block key; and denying the read request, in case the stored data block signature and the second data block signature do not match.

According to certain embodiments the logical object is represented by a data-structure, the data-structure comprising at least one path comprising a sequence of one or more metadata blocks referring to a respective data block; the method further comprising, prior to the reading of the physical data block: for one or more metadata blocks along one of the at least one path:

reading data related to a metadata block and an associated stored metadata block signature; calculating a second metadata block signature based on data related to the metadata block, the data identifying the logical object and a metadata block identifier associated with the metadata block; denying the protected read request in case the stored metadata block signature and the second metadata block signature do not match.

According to another aspect of the presently disclosed subject matter there is provided a storage system comprising: a control layer operatively connected to a physical storage space of the storage system, the physical storage space constituted by a plurality of physical data blocks stored in one or more storage devices; the control layer is operable to:

receive a protected read request related to a logical data block in a logical object, logically representing data stored in the physical storage space; wherein the read request comprises a respective block key; the block key comprises data identifying the logical object and data identifying the logical data block; read a physical data block including data related to the logical data block and an associated stored data block signature; calculate a second data block signature based on the data related to the logical data block and on the block key; and deny the read request, in case the stored data block signature and the second data block signature do not match.

According to certain embodiments the block key further comprises a security code identifying an accessing entity.

According to certain embodiments the logical object is represented by a data-structure, the data-structure comprising at least one path comprising a sequence of one or more metadata blocks referring to a respective data block; the control layer is further operable, for one or more metadata blocks along one of the at least one path, prior to the reading of the physical data block, to: read data related to a metadata block and an associated stored metadata block signature; calculate a second metadata block signature based on data related to the metadata block, the data identifying the logical object and a metadata block identifier associated with the metadata block; deny the protected read request in case the stored metadata block signature and the second metadata block signature do not match.

According to another aspect of the presently disclosed subject matter there is provided a storage system comprising: a control layer operatively connected to a physical storage space of the storage system, the physical storage space constituted by a plurality of physical data blocks stored in one or more storage devices; the control layer is operable to:

receive a protected write request related to a logical object, logically representing data stored in the physical storage space; wherein the request includes data to be written, related to a logical data block in the logical object, and a respective block key; the block key comprises data identifying the logical object and data identifying the logical data block; calculate a respective data block signature based on the data to be written and on the block key; store the data to be written and the respective data block signature in a same physical data block.

According to certain embodiments the logical object is represented by a data-structure, the data-structure comprising at least one path comprising a sequence of one or more metadata blocks referring to a respective physical data block; each of the one or more metadata blocks comprising a reference to a descendent metadata block or to a respective physical data block; the control layer is further operable, for one or more metadata blocks along the at least one path, to: calculate a respective metadata block signature based on data related to a metadata block, the data identifying the logical object and a metadata block identifier associated with the metadata block; store the data related to the metadata block and the respective metadata block signature in a same physical metadata block.

According to another aspect of the presently disclosed subject matter there is provided a program storage device readable by machine, tangibly embodying a program of instructions executable by the machine to perform method steps of storing data in a physical storage space of a storage system, the physical storage space constituted by a plurality of physical data blocks, the method comprising:

receiving a protected read request related to a logical data block in a logical object, logically representing data stored in the physical storage space; the read request comprises a respective block key; the block key comprises data identifying the logical object and data identifying the logical data block; reading a physical data block including data related to the logical data block and an associated stored data block signature; calculating a second data block signature based on the data related to the logical data block and on the block key; and denying access to data related to the logical data block, in the physical data block, in case the stored data block signature and the second data block signature do not match.

According to certain embodiments, the program storage device readable by machine, tangibly embodying a program of instructions executable by the machine to perform further method steps, includes:

receiving a protected write request related to a logical object, logically representing data stored in the physical storage space; wherein the request includes data to be written, related to a logical data block in the logical object, and a respective block key; the block key comprises data identifying the logical object and data identifying the logical data block; calculating a respective data block signature based on the data to be written and on the block key; and storing the data to be written and the respective data block signature in a same physical data block.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 illustrates a functional block diagram schematically illustrating a computer storage system, according to the presently disclosed subject matter;

FIG. 2a illustrates a schematic illustration of an example of a block key 200, according to the presently disclosed subject matter;

FIG. 2b illustrates a schematic illustration of an example of a physical data block 230 and an appended data block signature 240, according to the presently disclosed subject matter;

FIG. 3 illustrates a schematic illustration of a B-tree constructed according to the presently disclosed subject matter;

FIG. 4 is a flowchart illustrating a sequence of operations carried out for writing data, in accordance with the presently disclosed subject matter;

FIG. 5 is a flowchart illustrating a sequence of operations carried out for reading data, in accordance with the presently disclosed subject matter; and

FIG. 6 is a flowchart illustrating a sequence of operations carried out for reading data, in accordance with the presently disclosed subject matter.

### DETAILED DESCRIPTION

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “receiving”, “calculating”, “storing”, “identifying”, or the like, include action and/or processes of a computer that manipulate and/or transform data into other data, said data represented as physical quantities, e.g. such as electronic quantities, and/or said data representing the physical objects.

The operations in accordance with the teachings herein may be performed by a computer specially constructed for the desired purposes or by a general purpose computer specially configured for the desired purpose by a computer program stored in a computer readable storage medium.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

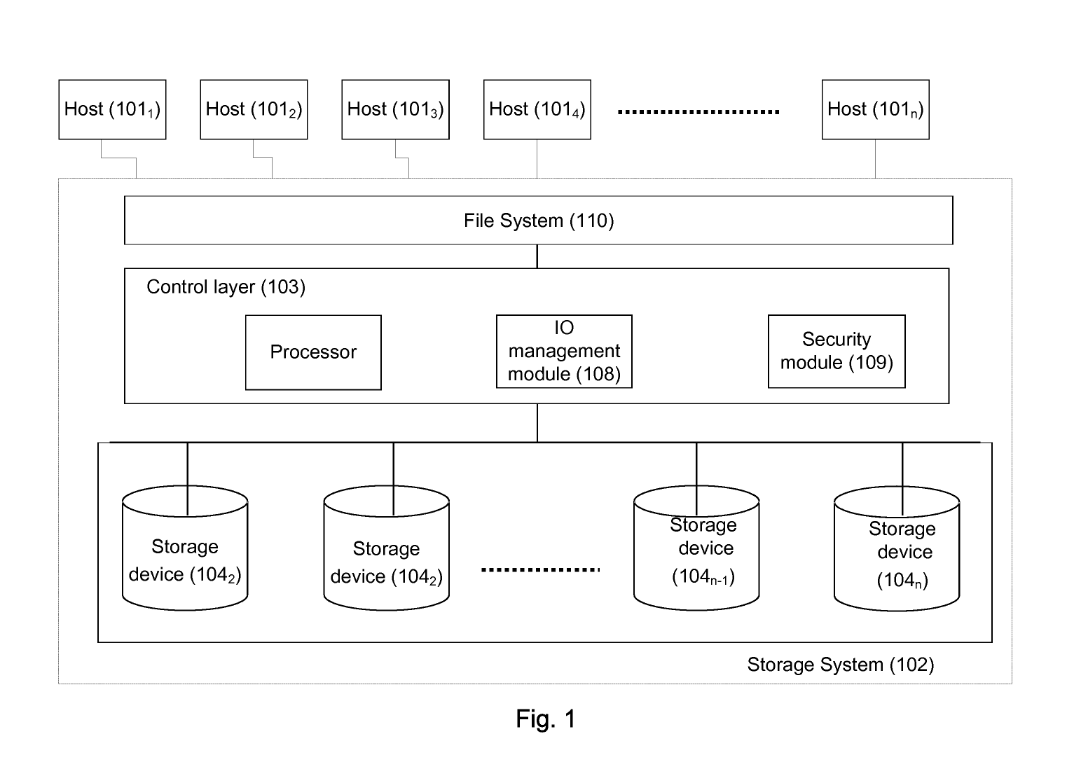

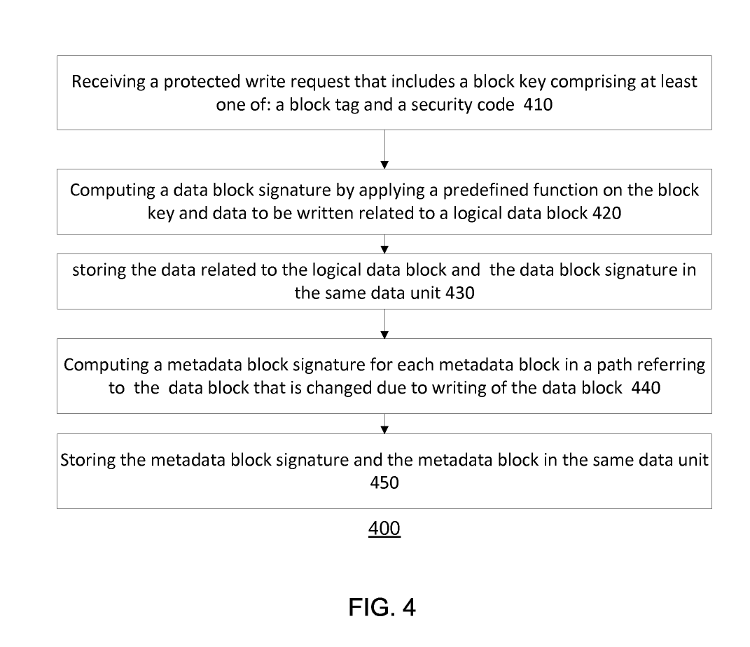

In embodiments of the presently disclosed subject matter, fewer, more and/or different stages than those shown in FIGS. 4, 5 and 6 may be executed. In embodiments of the presently disclosed subject matter one or more stages illustrated in FIGS. 4, 5 and 6 may be executed in a different order and/or one or more groups of stages may be executed simultaneously. FIG. 1 illustrates a general schematic of the system architecture in accordance with an embodiment of the presently disclosed subject matter. The modules in FIG. 1 may be centralized in one location or dispersed over more than one location. In other embodiments of the presently disclosed subject matter, the system may comprise fewer, more, and/or different modules than those shown in FIG. 1.

The presently disclosed subject matter includes a system and method for protecting stored data blocks, verifying their integrity and preventing unauthorized access to the data. According to the teachings disclosed herein, a block key is provided together with a read and a write request and is applied on data, which is related to a logical data block, for calculating a data block signature (e.g. a hash value that is key dependent). The block key includes information which is related to the identity of the logical data block and the identity of an object (e.g. file) comprising the logical data block. As explained below, this helps to ensure that data stored on a disk is accessed via their respective objects and thereby prevent malicious or unintended access to the data.

Attention is drawn to FIG. 1, which shows a functional block diagram schematically illustrating a computer storage system, according to the presently disclosed subject matter. FIG. 1 depicts one or more host computers 101₁₋ₙ illustrated as sharing common storage means provided by storage system 102. A host (101₁₋ₙ) can be for example a workstation, an external server, a group of servers, a port in a server, a laptop or personal computer, etc.

The storage system comprises a storage control layer 103 with one or more appropriate storage control devices operatively coupled to the plurality of host computers 101₁₋ₙ and to a plurality of data storage devices 104₁₋ₙ constituting a physical storage space optionally distributed over one or more storage nodes. Control layer 103 can be further coupled, either directly or via a network, to upper layer object storage facility, such as file-system 110 or an object store device (OSD). Thus, hosts 101₁₋ₙ can be directly coupled to control layer 103 or through upper layer applications, such as file-system 110.

Storage control layer 103 is operable to perform control operations including input/output (I/O) operations between hosts 101₁₋ₙ and data storage devices 104₁₋ₙ. Data storage devices 104₁₋ₙ are adapted for storing a plurality of data units. Connection between host computers 101₁₋ₙ and storage system 102 can be a direct connection and/or it may be established over a communication network. In some cases control layer 103 and data storage devices 104₁₋ₙ can be consolidated in a system located at the same location, while in other cases part or all of data storage devices 104₁₋ₙ can be located at one or more remote locations and communicate with control layer 103 over some type of remote communication network. The storage control layer 103 and storage devices 104₁₋ₙ may communicate with host computers 101₁₋ₙ and within the storage system in accordance with any appropriate storage protocol.

The control layer 103 can be further operable to handle a virtual representation of physical storage space (i.e. virtual address space) and to facilitate mapping between the physical storage space and its virtual representation (i.e. a logical storage space). Control layer 103 can be configured to create and manage at least one virtualization layer interfacing between elements of the computer system (host computers, etc.) external to the storage system and the physical storage space. The virtualization functions may be provided in hardware, software, firmware or any suitable combination thereof. Optionally, a format of logical representation provided by control layer 103 may differ, depending on interfacing applications.

Elements within control layer 103 can be implemented as centralized modules operatively connected to the plurality of storage control devices or can be distributed over a part or all storage control devices. Optionally, the functions of control layer 103 may be fully or partly integrated with one or more host computers and/or storage devices and/or with one or more communication devices enabling communication between the hosts and the storage devices.

The physical storage space may comprise any appropriate permanent storage medium including, by way of non-limiting example, one or more Solid State Disk (SSD) drives, Hard Disk Drives (HDD) and/or one or more disk units (DUs) also called “disk enclosures”, comprising several disk drives. The physical storage space comprises a plurality of data blocks (referred to herein as “physical data blocks”), each data block can be characterized by a pair (DD_{id}, DBA) where DD_{id} is a serial number associated with the disk drive accommodating the data block, and DBA is a logical block number within the respective disk.

The entire address space of the storage system can be divided into logical volumes, and each logical volume becomes an addressable device. A logical volume (LV) or logical unit (LU) represents a plurality of data blocks characterized by successive Logical Block Addresses (LBA). Different logical volumes may comprise different numbers of data blocks, which are typically of equal size within a given system (e.g. 512 bytes).

Typically, definition of LUs in the storage system involves in-advance configuring of an allocation scheme and/or allocation function used to determine the location of the various data portions across the physical storage medium. The allocation scheme can be handled for example, by an allocation module being a part of the storage control layer 103. The location of various data portions allocated across the physical storage can be recorded and monitored with the help of one or more allocation tables linking between logical data addresses and their corresponding allocated location in the physical storage. Logical contiguity of successive portions and physical contiguity of the storage location allocated to the portions in the system are not necessarily correlated.

As mentioned above control layer 103 can be further coupled, to an upper layer object storage facility, such as file-system 110 which enables to logically represent to a client (host), data stored in the physical storage space, in terms of logical objects within a logical storage space. Depending, inter alia, on the storage protocol, the logical objects may be volumes, data files, directories, access control lists (ACL), snapshots, etc. Logical data blocks within objects, such as files, are often assigned with logical block numbers (LBN) for identifying blocks within the object.

The storage control layer can further comprise a cache memory operable as part of the I/O flow in the system, a cache control module (aka cache manager), operable to control data activity in the cache and an I/O management module 108 for receiving and handling commands (including I/O commands) and enabling execution of the respective operations.

A read request according to the presently disclosed subject matter (referred to herein as “protected read request”), includes, in addition to data indicative of a requested data block, a block key for the purpose of verifying the data block signature that was stored upon the last write of the requested data block.

Similarly, a write request according to the presently disclosed subject matter (referred to herein as “protected write request”), includes, in addition to data indicative of a data block to be written, a block key for generating a respective data block signature.

According to the presently disclosed subject matter, I/O management module 108 can be operable to receive and process protected read request and protected write requests. I/O management module 108 can comprise or be otherwise associated with a security module 109 being operable, inter alia, for calculating a data block signature as described in more detail below.

The data block signature is appended to the data block and they are both stored in the same unit. Both data and signature are written or read in one I/O operation, so that there is no overhead of reading or writing a signature separately from the data block. Even though the data and signature are stored in the same unit, the problems, mentioned above in the background section, which typically arise when the data and checksum are stored together, are eliminated. This is due to the fact that the key that is used for calculating the signature is not written to the disk with the data, but is externally provided by an accessing entity (e.g. an entity that initiated the read/write request).

While some known methods for calculating checksums depend solely on the data they protect, (for example, when checksums are calculated with algorithms such as, exclusive or (XOR) of all the words, summing all the words and discarding any overflow bits, etc), the data block signature disclosed herein is dependent not only on the data but is also dependent on the key which is not part of the stored data, and is received from an entity accessing the storage system.

According to the presently disclosed subject matter, the data block signature can be utilized for verifying:
(i) the integrity of the data block—verifying that the content of the block is not corrupted;
(ii) the consistency of the data block—verifying that the block is the correct block, accessed via the correct path and via the correct object/file; and
(iii) the security of the data block—verifying that the block is accessed by an authorized entity.

Furthermore, as disclosed herein and explained in more detail below, the verification of the data is applied not only to data blocks, but also to metadata blocks that refer to the data blocks. This helps to prevent unauthorized access directly to a data block, rather than accessing the data block through the path defined by its metadata blocks, thus providing additional protection against malicious or unintended access to stored data.

Operations of control layer 103 including I/O management module 108 and data security and integrity module 109 are described below in detail, with reference to FIGS. 4 to 6.

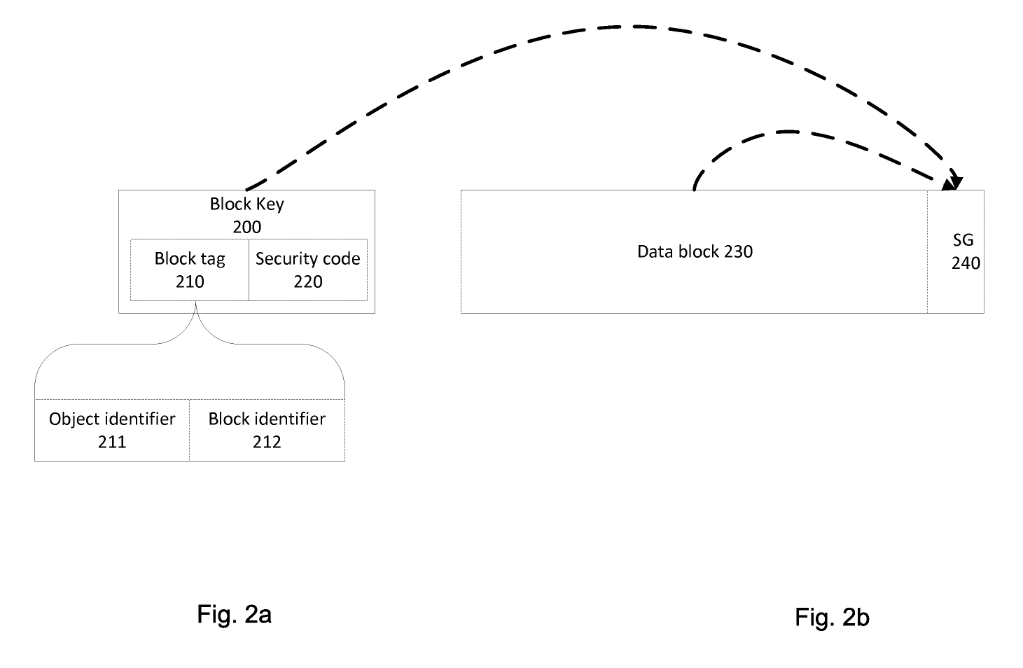

FIG. 2a is a schematic illustration of an example of a block key 200, according to the presently disclosed subject matter. Block key 200 includes one or both of: (i) a block tag 210; (ii) a security code 220. The block tag 210 includes data identifying a logical data block and data identifying the object it belongs to. The security code 220 identifies the accessing entity and can be used for authenticating that the accessing entity is authorized to access the relevant data and/or perform the requested task (e.g. read or write) on the relevant data.

According to one non-limiting example, object tag 210 can include an object identifier 211 (OID) and a block identifier 212 (BID). The OID is an identifier of the object, throughout the lifetime of the object. For example, in case the object is a file, an index-node (Mode) number of the file can be used as an OID, or in case the object is a directory, an Mode of the directory can be used as an OID.

Block identifier 212 uniquely identifies a logical data block within the object it belongs to. Block identifier 212 can identify a logical data block by its location relative to start of the object and may be for example a logical block number (LBN), which is the index of the block within the object. For example, LBNs of data blocks in a file comprising N data blocks can be numbered: 0, 1, 2 . . . N-1. Alternatively, other indications of the block location can be used as block identifiers, such as a logical block address that identifies the block within the volume or even a physical block address that identifies the block within a disk. However, among the advantages of using a block identifier that identifies the block within the object, is that it is less sensitive to changes in the block location in respect of the volume or disk. Thus, for example, in case a data block, which assigned internally in a file with LBN=2, is written to a different address (different LBA), either because a file has been moved or resulting from internal consideration of the underlying storage system, the LBN still remains LBN=2. Accordingly, the block tag is unchanged and the data block signature does not require recalculation.

Using a block key with an OID and a BID identifying a logical block in respect of the object (unlike, for example, the volume) also contributes to the data security in the storage system (even where a security code 220 is not used). Since the block key parameters are based on information derived from the object, this information is only available to authorized entities which have access to the object. Accordingly, this helps to prevent malicious or unauthorized attempts to access data through indirect paths, for example by browsing through a volume.

Security code 220 can be any type of data that is used for identifying the accessing entity. For example, a security code can include a password (or some calculated derivative thereof) which is provided by the accessing entity upon making the read or write request. Security module 109 can be configured to determined, based on pre-stored information, whether the accessing entity and the security code match, and allow the requested command only if they do match.

The security code 220 included in block key 200, or even the entire block key, when transferred from an accessing entity to the storage system, may be encrypted, by implementing symmetric or asymmetric key algorithms.

FIG. 2b illustrates an example of a physical data block 230 and an appended data block signature 240, according to the presently disclosed subject matter. The signature is calculated by applying a predefined function on the data block 230 and the block key 200. The block key 200 is not stored together with data block 230 and data block signature 240, which are stored in the same unit.

I/O management module 108 can be operable, upon receiving a protected write request from an accessing entity, to process the request and retrieve a block key 200 from the data received with the protected write request. I/O management module 108 can be further operable (e.g. with the help of security module 109) to calculate a data block signature by applying an assigned function on the block key and on the data to be written (also received in the write request) which is related to a logical data block. The calculated data block signature is appended to a physical data block written together with the signature to the disk.

Note, that the block key 200 that was used to calculate the data block signature is not written to the disk. Thus, the block key is only transmitted from the accessing entity to control layer 103. Once the signature is calculated at control layer 103, only the signature is further transmitted to the relevant storage device. This further contributes to the security of the system, as the block key cannot be maliciously obtained by intercepting the communication between control layer 103 and the physical storage layer.

The calculation of the data block signature may be implemented by using a cryptographic hash function in combination with a secret key. An example of such an encoding scheme is the Message Authentication Code (MAC) algorithm, sometimes called a keyed cryptographic hash function, that accepts as input a secret key and a message to be authenticated, and outputs a MAC. MAC algorithms can be constructed from other cryptographic primitives, such as cryptographic hash functions, but may also be constructed based on universal hashing. According to this example, security module 109 can be configured to run a MAC algorithm utilizing the block key as a secret key.

Furthermore, I/O management module 108 can be operable, upon receiving a protected read request from an accessing entity, to process the request and retrieve a block key 200 from the data received with the protected read request. I/O management module 108 can be further operable to read the data block specified in the read request from the respective disk along with its appended (stored) data block signature, and calculate (e.g. with the help of security module 109) a second data block signature by using the data read from the disk and the block key 200.

The second data block signature is then compared (e.g. with the help of security module 109) to the stored signature retrieved with the data block. If the second (computed) data block signature does not match the stored data block signature, the read request is denied.

Failure to match between the stored and computed data block signatures and the consequent denial of the read request can result from one of the following reasons:
(i) the data is corrupted; for example, in case the data in the data block that was read from the disk is different from the data that was previously used when the stored data block signature was calculated. This can result for example from an unintentional state switch of a bit from 0 to 1, or vice versa.
(ii) the block is not the requested block, i.e. either the LBN indicated in the block key does not match the LBN of the block or the block does not belong to the object indicated by the OID. In other words: the block is being read through an illegal path, which may be due to a software fault, an error of the accessing entity or due to malicious access;
(iii) the block is being accessed by a non-authorized entity, as the secure key 220 in the calculated data block signature does not correlate with the secure key used to calculate the stored data block signature.

As mentioned above, protected read and write requests that include block keys, as specified above, may be initiated by hosts 101₁₋ₙ. In this case, the hosts are referred to as the accessing entity and are configured to generate and send protected read and write requests. To this end host 101₁₋ₙ can comprise an appropriate process enabling a user application to issue protected read and write requests which include data indicative of block key 200.

A host 101₁₋ₙ can be operable to generate a block key 200 and incorporate the block key in a protected read or write request. For example, host 101₁₋ₙ can comprise an API (and an appropriate graphic user interface) enabling a user application to issue a file read and/or write request with the standard parameters and the API can be designed to generate a protected read or write request, for example by adding the key including the LBN and OID (e.g. the Mode of a respective file) to the request. Optionally, a host can also be configured to incorporate in the protected read/write request a security code (e.g. a password entered by a user).

Additionally or alternatively, standard read/write requests, can be initiated by host 101₁₋ₙ and a block key 200, can be added by an intermediary agent such as file-system 110, which can be operable to generate the protected read/write requests, based on a received standard read or write request. In this case, file-system 110 is considered the accessing entity.

According to the presently disclosed subject matter, in addition to protecting data blocks, metadata blocks of an object may also be protected. This is accomplished by using a metadata block key that is similar to a block key of a data block, but is adjusted to a metadata block. Unlike data blocks, a metadata block is not identified by an LBN, thus, according to the teaching disclosed herein, a metadata block key can include another kind of block identifier 112, to be used in the block tag. For example, a metadata block may be assigned with a unique metadata block identifier including data uniquely identifying the metadata block within the object, such as a random number.

It is beneficial to protect metadata blocks, which store pointers to data blocks of the object and are therefore accessed upon read/write requests, in order to further protect against malicious and/or unauthorized access to the data. Thus, according to the presently disclosed subject matter, such metadata blocks can be assigned with metadata block keys, which are facilitated for calculating respective metadata block signatures. Examples of metadata blocks that store pointers to data blocks of the object are: indirect block pointed by an inode, B-tree's index nodes that store pointers to other nodes in the B-tree or to the data blocks, etc.

The following is an example for implementing metadata blocks protection by using metadata block keys. The example assumes that metadata blocks are arranged as a B-tree data-structure associated with the object, which is a common data-structure for storing data blocks of an object. B-trees are used for mapping object data blocks (identified by LBNs) into blocks of data in the volume (identified by LBAs). A path in a B-tree comprises a sequence of one or more metadata blocks which refer to a data block.

It is noted that this example should not be construed as limiting in any way and the implementation of metadata blocks protection as disclosed herein can be applied to other data-structures (e.g. linked lists or graphs).

Similar to a data block signature, a metadata block signature can be calculated and appended to the metadata blocks and stored together in the same unit (e.g. in the same physical metadata block). The metadata block key of a metadata block can include some of the elements related to the block key of its descendent data block, e.g. the same OID 211 and the same security code 220 of the block key 200 used for calculating the signature of the data block. However, instead of using a block tag 210 that includes an LBN as a block identifier 212, a different metadata block identifier is used wherein the metadata block identifier may be stored as part of the metadata information, for example in the parent metadata block.

An entry in a leaf node of the B-tree, includes an LBN and an LBA, which points to the data block (or to a starting point of an extent). An index node (i.e. non-leaf node) includes LBNs as keys of the node entries (LBNs identifying respective data blocks which are referenced by the index node). A node in a B-tree can include a metadata block identifier of a descendent metadata block corresponding to a descendent node in the B-tree.

File-system 110 can be operable to read metadata blocks related to data blocks requested in the protected read and write requests. File-system 110 can be operable to associate each metadata block with its associated metadata block identifier, by e.g. storing the metadata block identifier in a parent metadata block that points to the metadata block. File-system 110 can be further operable to generate a metadata block key by combining the OID and the metadata block identifier that was previously read (also in a protected manner) as part of the parent metadata block. File-system 110 can then send a protected read request for the metadata block to control layer 103.

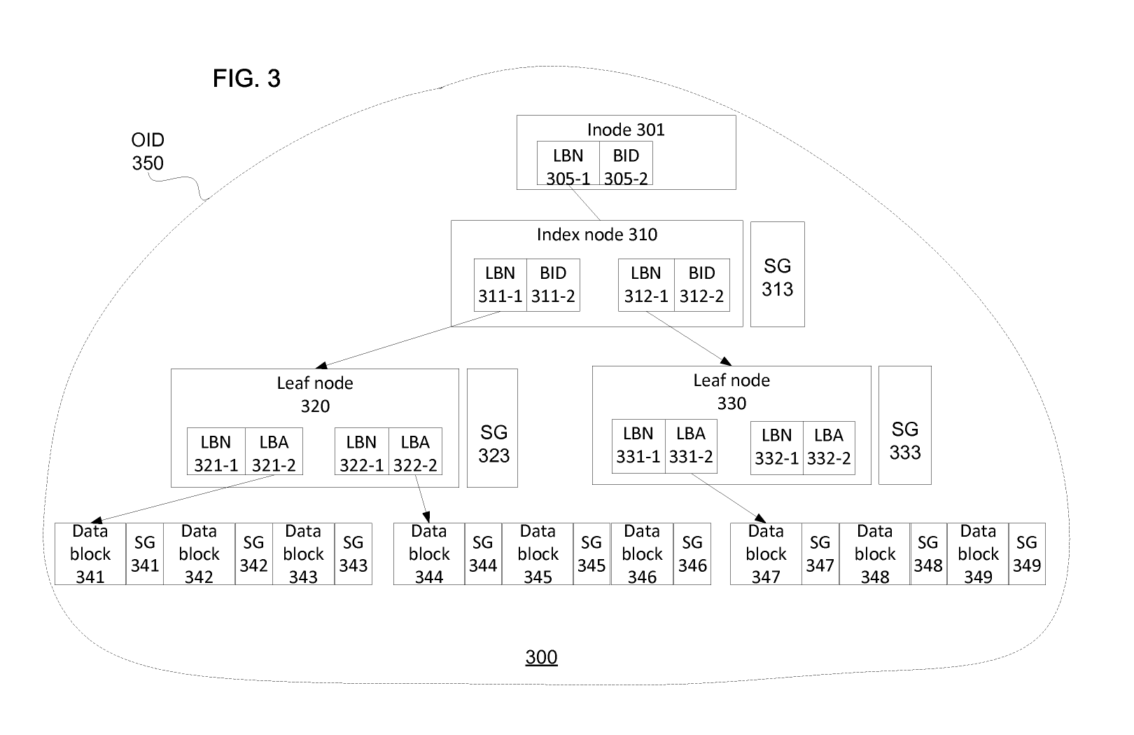

FIG. 3 is a schematic illustration of an example of a B-tree constructed according to the presently disclosed subject matter. FIG. 3 demonstrates a B-tree 300 representing an object with OID 350. File-system 110 can be operable to generate B-tree 300 when an object is created in order to map the blocks in the generated object to the blocks within a respective volume generated by control layer 103. A node in a B-tree corresponds to a metadata block. In some cases part of the metadata blocks in a B-tree are dynamically generated when the file size is increased and additional data blocks are allocated to the file.

A data block is referenced by a path in the B-tree comprising a sequence of nodes each corresponding to a metadata block. A path begins at the Mode and progresses down to a respective leaf node which points to a respective data block. OID 350 is associated with multiple metadata blocks including index node 310 that is referenced by an Mode entry 301, and leaf nodes 320, 330 that are referenced, respectively, by entries 311 and 312 of index node 310. The non-leaf nodes include in their entries a metadata block identifier of each of the metadata blocks which are their descendants. For example, BID 311-2 may store the metadata block identifier of metadata block (leaf node) 320, BID 312-2 may store the metadata block identifier of metadata block (leaf node) 330, and BID 305-2 of Mode entry 301 may store the metadata block identifier of index node 310.

Suppose for example a read request refers to a data block 341 of OID 350. The path for accessing data block 341 of OID 350 involves: Mode entry 301, index node 310, leaf node 320 and data block 341. First metadata block (index block) 310 is read along with its stored metadata block signature. The metadata block key of metadata block 310 is composed of: (i) a metadata block tag that includes: object identifier 211 (in this case OID 350) and a metadata block identifier that is stored in Mode 301; and (ii) a secure key—if provided in the read request.

A metadata block signature is computed by applying a predefined function on the metadata block key and metadata block 310, and the result is compared to the stored metadata block signature (e.g. SG 313) If the two signatures mismatch, the read request is denied. Otherwise, the same process is repeated for metadata block (leaf node) 320, wherein its metadata block identifier is obtained from BID 311-2 of metadata block 310 (the same OID and security code as before are used). The next step is to calculate the block signature of data block 341. At any stage, if a signature mismatch is detected, the read request is denied.

The protected tree disclosed herein provides similar protection to that obtained by using Merkle trees, but without the overhead of computing the checksum every time the checksum of a lower level node is changed. Merkle trees store the checksum itself as part of the parent nodes, while according to the presently disclosed subject matter, a unique metadata block identifier(e.g. a random number) is stored in a parent node. This metadata block identifier is not changed when the metadata block of the lower level block is changed. Thus, there is no need to update the parent nodes of node that has been changed.

Proceeding to FIG. 4 illustrates a flowchart illustrating a sequence of operations carried out for protected writing, in accordance with the presently disclosed subject matter. The operation described with reference to FIG. 4 can be performed for example by I/O management module 108 and/or file-system 110.

At block 410 a protected write request is received. In addition to data to be written, which is associated with a logical block in a respective object, (and any other information which may be incorporated in a write request as known in the art), a protected write request includes a block key 200. The block key 200 includes at least one of: a block tag 210 and a security code 220. As explained above, the block tag 210 includes data identifying a logical data block and data identifying the object it belongs to and may include an object identifier (OID 111) such as an Mode and a block identifier (BID 112) such as logical block number (LBN) of a block within the object.

At block 420 a block signature is computed. The block signature can be computed by applying a predefined function on the block key and the data to be written related to the logical data block. The function can be for example a keyed cryptographic hash function. Once calculated, the block signature is appended and stored together with the data in a disk drive in the same data unit e.g. in one physical data block (block 430).

Optionally, in case metadata blocks are being protected by metadata block signatures, the operations described with reference to blocks 420 and 430 are repeated for each metadata block along a path referring to a data block that are changed due to writing of the data block (blocks 440 and 450). As explained above, metadata block signatures are calculated based on information which stays constant throughout the life of the object. Thus, in general when the write request is an update request of an existing data block, metadata block signatures of metadata blocks which refer to the updated block are not updated. If, however, the write request is directed for writing a new data block, or causing a change in metadata blocks requires adding new metadata blocks, metadata block signatures are calculated and associated with the metadata blocks which refer to the newly written data block.

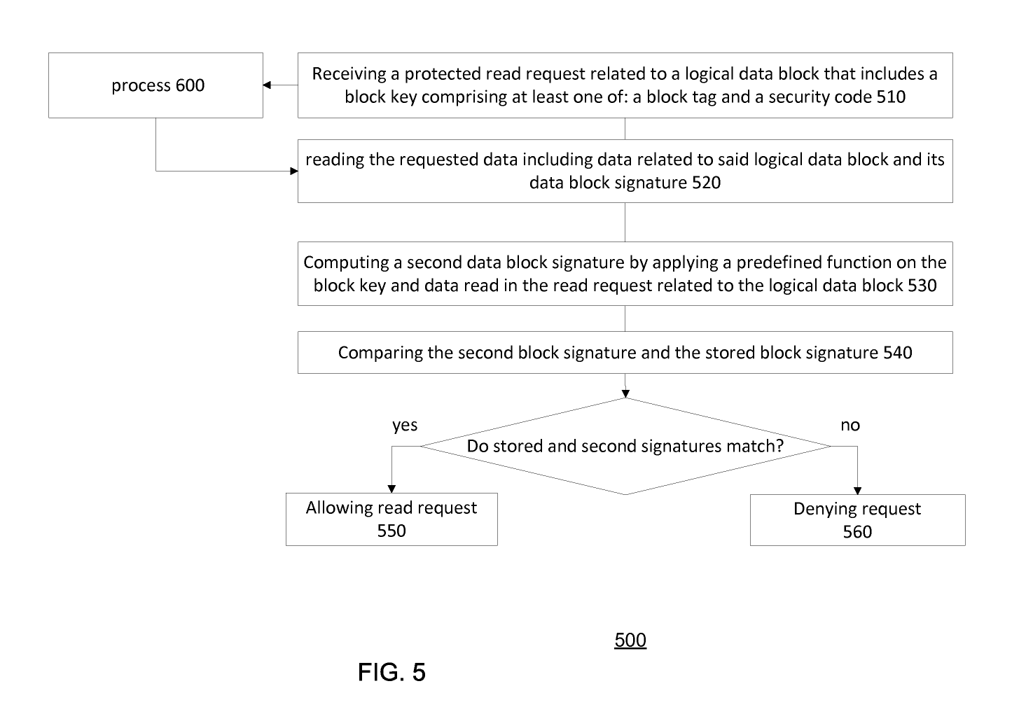

FIG. 5 is a flowchart illustrating a sequence of operations carried out for protected reading, in accordance with the presently disclosed subject matter. The operation described with reference to FIG. 5 can be performed for example with the help of I/O management module 108 and/or file-system 110.

At block 510 a protected read request is received. Similar to the protected write request, in addition to information indicating data to be read, related to a logical data block (and any other information which may be incorporated in a write request as known in the art), a protected read request includes a block key 200, which comprises at least one of: a block tag 210 and a security code 220.

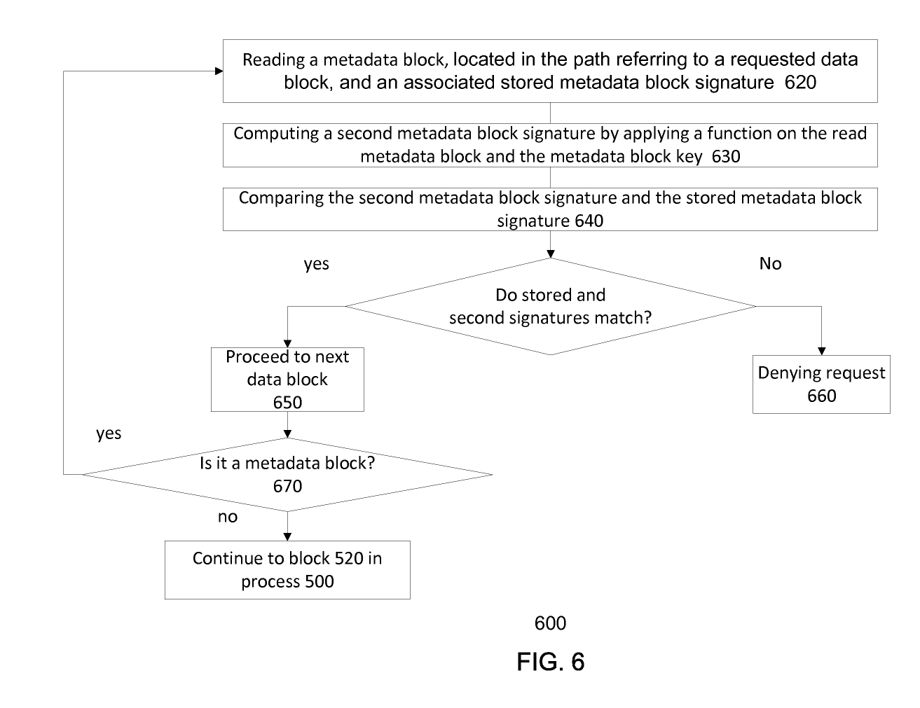

Optionally, in case metadata blocks are being protected by metadata block signatures, the process continues from block 510 to process 600 described below with reference to FIG. 6.

At block 520 the requested physical data block related to said logical data block, is read from the disk together with a stored data block signature, which is appended to the physical data block. A second data block signature is computed by applying a predefined function on the block key and data read from the disk related to the logical data block (block 530). The second (i.e. computed) data block signature is compared to the stored data block signature and it is determined whether the two block signatures match (block 540). In case the two block signatures match, the read request is allowed and the data can be provided to the requesting entity (block 550). Otherwise, the read request is denied (block 560).

FIG. 6 is a flowchart illustrating a sequence of operations carried out for protected reading of protected metadata blocks, in accordance with the presently disclosed subject matter. Optionally, in case metadata blocks are protected by metadata block signatures as described above, during the reading process the signature of each metadata block is checked as well.

At block 620 the first metadata block in the path referring to a requested data block is read from the disk together with its metadata block signature. A second metadata block signature is computed by applying a predefined function on the read metadata block and a respective metadata block key (block 630). The metadata block identifier is stored in association with a parent metadata block.

The second (i.e. computed) metadata block signature is compared to the stored metadata block signature and it is determined whether the two metadata block signatures match (block 640). In case the two metadata block signatures mismatch, the read request is denied (block 660). Otherwise, the process continues to process the next block (block 650). In case the next block is another metadata block, the process returns to block 620. Otherwise, in case it is a data block, the process turns to process the data as described in FIG. 5.

FIG. 1, described above, illustrates a general schematic of the system architecture in accordance with an embodiment of the presently disclosed subject matter. Certain embodiments of the present invention are applicable to the architecture of a computer system described with reference to FIG. 1. However, the invention is not bound by the specific architecture; equivalent and/or modified functionality may be consolidated or divided in another manner and may be implemented in any appropriate combination of software, firmware and hardware. Those versed in the art will readily appreciate that the invention is, likewise, applicable to any computer system and any storage architecture implementing a virtualized storage system. In different embodiments of the invention the functional blocks and/or parts thereof may be placed in a single or in multiple geographical locations (including duplication for high-availability). Control layer 103 in FIG. 1 comprises or is otherwise associated with at least one processor operable for executing operations as described above. The term “processor” should be expansively construed to cover any kind of electronic device with data processing capabilities, including, by way of non-limiting example, a personal computer, a server computer, a computing system, a communication device, a processor (e.g. digital signal processor (DSP), a microcontroller, a field programmable gate array (FPGA), an application specific integrated circuit (ASIC), etc.), or any other electronic computing device, and or any combination thereof. Operative connections between the blocks and/or within the blocks may be implemented directly (e.g. via a bus) or indirectly, including remote connection. Connections between different components in illustrated in FIG. 1, may be provided via Wire-line, Wireless, cable, Internet, Intranet, power, satellite or other networks and/or using any appropriate communication standard, system and/or protocol and variants or evolutions thereof (as, by way of unlimited example, Ethernet, iSCSI, Fiber Channel, etc.).

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter may be a suitably programmed computer. Likewise, the presently disclosed subject matter contemplates a computer program being readable by a computer for executing the method of the presently disclosed subject matter. The presently disclosed subject matter further contemplates a machine-readable memory tangibly embodying a program of instructions executable by the machine for executing the method of the presently disclosed subject matter.

1. A method of storing data in a physical storage space of a storage system, the physical storage space constituted by a plurality of physical data blocks, the method comprising:
receiving a protected write request related to a logical object, logically representing data stored in said physical storage space; the request comprises data to be written, related to a logical data block in said logical object, and a respective block key; the block key comprises data identifying the logical object and data identifying the logical data block;
calculating a respective data block signature based on the data to be written and on the block key;
storing the data to be written and the respective data block signature in a same physical data block.

2. The method according to claim 1 wherein said block key further comprises a security code identifying an accessing entity.

3. The method according to claim 1 wherein said data, identifying said logical data block, is a logical block number, identifying the logical data block within the logical object.

4. The method according to claim 1, wherein said protected write request is generated by a host operatively connected to the storage system.

5. The method according to claim 1, wherein said protected write request is generated by an object storage facility interfacing between a host, operatively connected to said storage system, and said storage system.

6. The method according to claim 5, wherein said object storage facility is a file-system, said logical object is a file and said data identifying said logical object, is an Mode of said file.

7. The method according to claim 1 wherein said logical object is represented by a data-structure, said data-structure comprising at least one path comprising a sequence of one or more metadata blocks referring to a respective data block; each of said one or more metadata blocks comprising a reference to a descendent metadata block or to a respective data block; the method further comprising:
for one or more metadata blocks along said at least one path:
calculating a respective metadata block signature based on data related to a metadata block, the data identifying said logical object and a metadata block identifier associated with said metadata block;
storing said data related to the metadata block and the respective metadata block signature in a same data block.

8. The method according to claim 7 further comprising: storing a metadata block identifier of a descendent metadata block, in association with said metadata block.

9. The method according to claim 7 wherein said metadata block identifier is a number uniquely identifying said metadata block within said logical object.

10. The method according to claim 8 wherein said data-structure is a B-tree.

11. The method according to claim 1 wherein said data block signature is calculated by applying a predefined function on the data to be written and on the block key.

12. A method of storing data in a physical storage space of a storage system, the physical storage space constituted by a plurality of physical data blocks, the method comprising:
receiving a protected read request related to a logical data block in a logical object, logically representing data stored in said physical storage space; wherein the protected read request comprises a respective block key; the block key comprises data identifying the logical object and data identifying the logical data block;
reading a physical data block including data related to said logical data block and an associated stored data block signature;
calculating a second data block signature based on the data related to said logical data block and on the block key; and
denying the read request, in case said stored data block signature and said second data block signature do not match.

13. The method according to claim 12, wherein said logical object is represented by a data-structure, said data-structure comprising at least one path comprising a sequence of one or more metadata blocks referring to a respective data block; the method further comprising, prior to the reading of said physical data block:
for one or more metadata blocks along one of said at least one path:
reading data related to a metadata block and an associated stored metadata block signature;
calculating a second metadata block signature based on data related to said metadata block, the data identifying said logical object and a metadata block identifier associated with said metadata block;
denying the protected read request in case said stored metadata block signature and said second metadata block signature do not match.

14. The method according to claim 13 further comprising: storing a metadata block identifier of a descendent metadata block, in association with said metadata block.

15. A storage system comprising:
a control layer operatively connected to a physical storage space of said storage system, the physical storage space constituted by a plurality of physical data blocks stored in one or more storage devices; the control layer is operable to:
receive a protected read request related to a logical data block in a logical object, logically representing data stored in said physical storage space; wherein the read request comprises a respective block key; the block key comprises data identifying the logical object and data identifying the logical data block;
read a physical data block including data related to said logical data block and an associated stored data block signature;
calculate a second data block signature based on the data related to said logical data block and on the block key; and
deny the read request, in case said stored data block signature and said second data block signature do not match.

16. The storage system according to claim 15, wherein said block key further comprises a security code identifying an accessing entity.

17. The storage system according to claim 15, wherein said data, identifying said logical data block, is a logical block number, identifying the logical data block within the logical object.

18. The storage system according to claim 15, wherein said protected write request is generated by a host operatively connected to the storage system.

19. The storage system according to claim 15, wherein said control layer is operatively connected to an object storage facility interfacing between a host and said storage system; the object storage facility being configured to generate the protected read request.

20. The storage system according to claim 19, wherein said object storage facility is a file-system, and said logical object is a file in the file-system and said data, identifying said logical object, is an Mode of said file.

21. The storage system according to claim 15, wherein said logical object is represented by a data-structure, said data-structure comprising at least one path comprising a sequence of one or more metadata blocks referring to a respective data block; the control layer is further operable, for one or more metadata blocks along one of said at least one path, prior to the reading of said physical data block, to:
read data related to a metadata block and an associated stored metadata block signature;
calculate a second metadata block signature based on data related to said metadata block, the data identifying said logical object and a metadata block identifier associated with said metadata block;
deny the protected read request in case said stored metadata block signature and said second metadata block signature do not match.

22. The storage system according to claim 21, wherein said control layer is further operable to store metadata block identifier of a descendent metadata block, in association with said metadata block.

23. The storage system according to claim 21, wherein said metadata block identifier is a number uniquely identifying said metadata block within said logical object.

24. The storage system according to claim 15, wherein said control layer is further operable to calculate said data block signature by applying a predefined function on the data to be written and on the block key.

25. The storage system according to claim 15, wherein said control layer is further operable to:
receive a protected write request related to said logical object; the request includes data to be written, related to said logical data block in said logical object, and said respective block key;
calculate said respective data block signature based on the data to be written and on the block key;
store the data to be written and the respective data block signature in a same physical data block.

26. The storage system according to claim 25, wherein said logical object is represented by a data-structure, said data-structure comprising at least one path comprising a sequence of one or more metadata blocks referring to a respective physical data block; each of said one or more metadata blocks comprising a reference to a descendent metadata block or to a respective physical data block; the control layer is further operable, for one or more metadata blocks along said at least one path, to:
calculate a respective metadata block signature based on data related to a metadata block, the data identifying said logical object and a metadata block identifier associated with said metadata block;
store said data related to the metadata block and the respective metadata block signature in a same physical metadata block.

27. The storage system according to claim 15, wherein said control layer comprises an I/O management module and at least one processor.

28. A program storage device readable by machine, tangibly embodying a program of instructions executable by the machine to perform method steps of storing data in a physical storage space of a storage system, the physical storage space constituted by a plurality of physical data blocks, the method comprising:
receiving a protected read request related to a logical data block in a logical object, logically representing data stored in said physical storage space; wherein the read request includes a respective block key; the block key comprises data identifying the logical object and data identifying the logical data block;
reading a physical data block including data related to said logical data block and an associated stored data block signature;
calculating a second data block signature based on the data related to said logical data block and on the block key; and
denying the read request, in said physical data block, in case said stored data block signature and said second data block signature do not match.

29. The program storage device according to claim 28, wherein said method steps further include:
receiving a protected write request related to a logical object, logically representing data stored in said physical storage space; wherein the request includes data to be written, related to a logical data block in said logical object, and a respective block key; the block key comprises data identifying the logical object and data identifying the logical data block;
calculating a respective data block signature based on the data to be written and on the block key; and
storing the data to be written and the respective data block signature in a same physical data block.
